(19) United States
(12) Patent Application Publication
(10) Pub. No.: US 2005/0067353 A1
(43) Pub. Date: Mar. 31, 2005

(54) Molecular motility device

(76) Inventor: Hans E. Haas, Stow, OH (US)

Correspondence Address: GIFFORD, KRASS, GROH, SPRINKLE & CITKOWSKI, P.C, PO BOX 7021, TROY, MI, 48007-7021, US

(21) Appl. No.: 10/954,737

(22) Filed: Sep. 30, 2004

Related U.S. Application Data
(60) Provisional application No. 60/507,475, filed on Sep. 30, 2003.

(51) Int. Cl. C02F 1/48

(52) U.S. Cl. 210/695; 210/222; 210/748

(57) ABSTRACT

A fluid motility device includes a substrate and a plurality of molecules bound to a surface of the substrate. Each of the molecules each contain a ferromagnetic, photoactive or ionic moiety. A fluid is contacted with the plurality of molecules. A non-static electromagnetic field generator or photonic generator output impinges on the substrate for moving the molecules in a concerted manner relative to the surface so as to move the fluid. A process for moving a fluid includes placing a surface into contact with a fluid, where the surface has bound thereto a plurality of molecules each containing a ferromagnetic moiety. Activation of an electromagnet in proximity to the surface urges the molecules into a concerted movement relative to the surface resulting in fluid movement.

### RELATED APPLICATION

This application claims priority of U.S. Provisional Application Ser. No. 60/507,475 filed Sep. 30, 2003, which is incorporated herein by reference.

### FIELD OF THE INVENTION

The present invention in general relates to molecules tethered to a substrate that are displaced in response to the application of an electromagnetic or photonic field, and in particular to a device utilizing the concerted motion of tethered molecules to displace a fluid in contact with the molecules.

### BACKGROUND OF THE INVENTION

The movement of fluids has historically relied upon either suction or mechanical forces to compress the liquid and thereby urge the fluid in a particular direction. Owing to the limited number of circumstances where suction or capillary action is an efficient mechanism to move fluids, most fluid movement in opposition to the forces of gravity is performed by mechanical pumping. The common feature of all forms of mechanical pumping is a moving component such as an impeller, a piston, an auger gear, a cam or elevator. The time and interrupted service associated with the maintenance and repair of mechanical fluid pumping components represents a limitation in conventional fluid pumping schemes. Thus, a mechanical pumping scheme lacking components subject to mechanical failure improves the reliability of such a device. Additionally, the controlled flow of small volumes of fluid has represented an ongoing problem for conventional fluid movement techniques. In a size regime where fluid cross sections are less than about 1 millimeter, fluid surface tension is a force of comparable magnitude to gravity. While capillary techniques are capable of delivering such small volumes of fluid, changes in fluid delivery rate are difficult. The controlled delivery of small volumes of fluid has become of increasing technological importance as a result of advanced cell culturing techniques and the focus of vascular surgery in reconstructing ever-smaller vessels. Thus, there exists a need for a device and method capable of displacing fluid in a controlled manner absent moving mechanical components.

### SUMMARY OF THE INVENTION

A fluid motility device includes a substrate and a plurality of molecules bound to a surface of the substrate. Each of the molecules each contain a ferromagnetic, photoactive or ionic moiety. A fluid is contacted with the plurality of molecules. A non-static electromagnetic field generator or photonic generator output impinges on the substrate for moving the molecules in a concerted manner relative to the surface so as to move the fluid.

A process for moving a fluid includes placing a surface into contact with a fluid, where the surface has bound thereto a plurality of molecules each containing a ferromagnetic moiety. Activation of an electromagnet in proximity to the surface urges the molecules into a concerted movement relative to the surface resulting in fluid movement.

### BRIEF DESCRIPTION OF THE DRAWINGS

FIG. 1 is a partial cutaway view of an inventive device where the relative size of the bound polymers has been expanded for illustrative purposes; and

FIG. 2 is a partial cutaway view of an alternate embodiment of an inventive device where the relative scale of the bound polymers has been increased for illustrative purposes.

### DESCRIPTION OF THE PREFERRED EMBODIMENTS

The present invention has utility in moving fluid relative thereto. The present invention utilizes an oscillating electromagnetic field or photonic source to move an array of bound molecules that contain a ferromagnetic, ionic, or photoactive moiety therein. The coordinated motility of bound molecules exerts a force on a surrounding fluid. Depending on the geometry of the bound molecule array, the present invention is operative as a fluidic pump, a bath agitator, or a propulsion system for a miniaturized device.

According to the present invention, a substrate is selected that is capable of forming a covalent or coordinate covalent bond with an electromagnetic responsive molecule. The formation of self-assembled monolayers or otherwise chemically binding molecules to a solid substrate is well known to the art. Illustrative of these chemistries are the binding of organothiols to gold, silanol reaction with a silicate glass, the reaction of silicon hydride with an olefin and olefinic unsaturation reaction with metals in the presence of sulfur. A surface bound molecule according to the present invention incorporates as an operative moiety at least one ferromagnetic, ionic or photoactive moiety. Preferably, two or more operative moieties would be distributed along the length of the bound molecule. The moiety may be part of the main chain or pendant to the main chain. A ferromagnetic moiety operative in the present invention illustratively includes a chelated ferromagnetic ion, ferromagnetic atom, or a ferromagnetic nanocrystal. An ionic moiety includes salts of carboxylic acid, sulfonic acid, phosphinic or phosphonic acid and the salts of primary, secondary, tertiary or quaternary amines and mercaptides or alkoxides. A photoactive moiety includes a species that undergoes rotation or steric changes under the influence of a given wavelength of light and illustratively includes rhodopsin and cytochrome 450. Preferably, the operative moiety is disposed proximal to the unbound terminus of the molecule or a repeating subunit of the molecule. It is appreciated that a bound molecule operative in the present invention is linear, branched or dendritic, and contains repeating subunits or is simply an asymmetric molecule having at least seven linear non-hydrogen atoms between the substrate and the operative moiety. Preferably, the bound molecule would contain twenty or more linear non-hydrogen atoms with operative moieties spaced at regular intervals along its length.

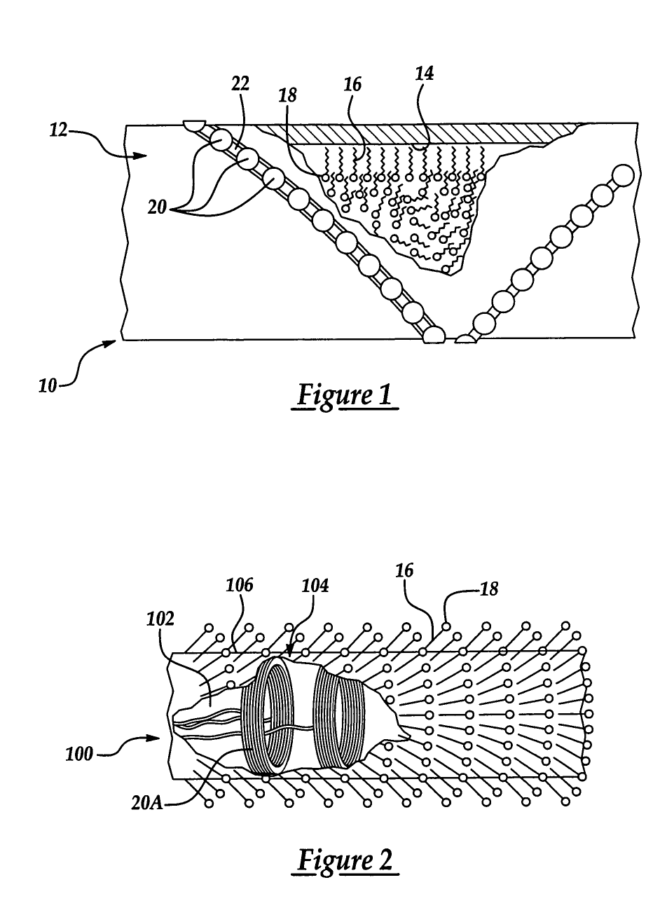

Referring now to FIG. 1, the inventive device operative as a fluidic pump is shown generally at 10. A conduit 12 has an interior surface 14. Molecules 16 containing operative moieties 18 are bound to the interior surface 14 through covalent bonds. The operative moiety 18 extended a sufficient distance from the interior surface 14 so that the remainder of the molecule 16 serves as a spring about which the operative moiety 18 flexes. A plurality of electromagnets 20 extend along the length of the conduit 12 in the case of a ferromagnetic moiety. Leads 22 allow for the sequential activation of electromagnets 20. Upon an electromagnet 20 being energized, an operative moiety 18 is induced to move attractively or repulsively relative to the interior wall 14 of the conduit 12, depending on the magnetic polarity relative to the orientation of the operative moiety 18. The movement of the operative moiety 18 and the flexure of the remainder of the bound molecule 16 also causes movement of a fluid within the conduit 12. By energizing each of the plurality of electromagnets 20 and for a controlled duration, various waveforms of bound molecules flexing and thereby propelling liquid through the conduit 12 is achieved. It is appreciated that a bound molecule is optionally allowed to return to a relaxed state through deactivation of proximal electromagnets. Alternatively, an inventive device is also operative with a conductive wire or optical fiber conveying photoactive wavelengths therethrough. In the instance where a conductive wire is present, it alternates in polarity so as to urge an operative moiety 18 bound molecule 16 between attractive and repulsive conditions relative to electromagnet polarity. In a preferred embodiment, the electromagnets or conductive wire are activated along the length of conduit 12 so as to propagate a molecular-motility wave through the pump 10. It is appreciated that relaxation of the molecules 16 to an orientation away from the interior 14 of the conduit 12 can occur either through propagating an opposite polarity electromagnet activation or by leaving the electromagnet in a deactivated state for a sufficient time to allow for molecular orientation relaxation.

In a preferred embodiment, a course of electromagnets, a voltage lead, or an optical fiber is spiral wound relative to a substrate. Activation of a spiral course, lead or fiber induces a spiral deflection of molecules proximal thereto, thereby creating a net fluid movement along the activation axis. Optionally, two or more such spiral courses, leads or fibers are present to enhance the formation of a fluid vortex through coordinated activation and/or deactivation.

As an alternate to a spiral field along the length of a surface coated with operative molecules, an alternating current activation is induced in a direction generally parallel to the intended direction of fluid flow. Preferably, the activation field is such that about one-quarter of a full sine wave is induced along the length of a bound molecule. It is appreciated that the binding of different molecules of differing length and therefore a different modulation frequency can be stimulated by an alternative activation wave having temporally offset activation frequencies contained therein.

An alternate embodiment operative as a fluidic agitator or locomotion system is depicted generally at 100 in FIG. 2, where like numerals correspond to those described with respect to FIG. 1. A core 102 contains at least one electromagnet 20. A sheath 104 that defines the core 102 has an exterior surface 106. The exterior surface 106 has bound thereto molecules 16 having operative moieties 18. The activation of the at least one electromagnet 20, optical fiber or a conductive wire urges the operative moiety 18 into either an attractive or repulsive orientation based upon the polarity of the electromagnetic field or the photo response induced. The movement of the molecules 16 causes movement of a fluid surrounding the sheath 106 and in contact with the molecules 16. Preferably, a plurality of electromagnets, fibers or wires are disposed within the core 102. More preferably, a plurality of electromagnets, fibers or wires are sequentially activated and deactivated to induce a motility wave within the molecules 16 along the length of the exterior surface 106. It is appreciated that the anchoring of the device 100 relative to a surrounding fluid creates a fluidic agitator whereas the ability of the device 100 to move relative to a surrounding fluid creates a locomotion system.

A locomotion system finds particular application with respect to the movement of a MEMS structure. It is appreciated that while a single device 100 is capable of generating motion forward and backward relative to the linear axis of the device 100, maneuverability requires at least two such structures 100, each operable independently. Examples of cilia-induced locomotion designs are found in numerous microorganisms and plankton. While electrical energy to operate an inventive device in a stationary setting operating as a pump or agitator is readily supplied, in a locomotion application, a battery source, static electricity, or photonic energy is utilized to energize the at least one electromagnet. In absence of an internal power source, an inventive device is optionally powered remotely by the inductive effect.

It is appreciated that to create locomotion, the motion can be created and/or navigated by an externally generated field as well. In this case, its position could be tracked and directed by incorporating a low power photon emission source (e.g. radio frequency) and using triangulation for position management.

The parameters considered in producing an operative inventive device include electromagnetic field strength, electromagnetic field waveform, wavelength of light stimuli and intensity, conduit diameter and the identity of the bound molecule and ferromagnetic or ionic moiety. The calculation of magnetic parameters upon the selection of a bound molecule is well known within the field of nuclear magnetic resonance.

### EXAMPLE

A glass capillary tube having an internal diameter of 1 millimeter was internally coated with a gold paste. Upon drying to form a continuous gold film on the interior of the capillary, 16-mercaptohexadecanoic acid (2-chlorophenyl)diphenylmethyl ester was adhered to the gold film to form a self-assembled monolayer as detailed in J. Lahann et al., Science, 299, 117/03, pp. 371-374. After self-assembly, the interior of the glass capillary was exposed to a 0.1 molar solution of Fe(III) chloride for one hour and allowed to dry. The capillary was rinsed with the ionized water and placed into a fluid reservoir at an angle of 45° and surrounded by 6 equally spaced electromagnetic coils. Energizing each of the coils to generate a field of about 0.5 Tesla for 0.5 seconds followed by sequential activation of the next coil created a pumping of deionized water from the reservoir out through the upper end of the capillary.

Any publications mentioned in the specification are indicative of the levels of those skilled in the art to which the invention pertains. These publications are herein incorporated by reference to the same extent as if each individual publication was specifically and individually indicated to be incorporated by reference.

1. A fluid motility device comprising:
a substrate having a surface and a length;
a plurality of molecules bound to the surface of said substrate, said plurality of molecules each containing a ferromagnetic, photoactive or ionic moiety;
a body of fluid in contact with said plurality of molecules; and
at least one non-static electromagnetic field generator or photonic generator for moving said plurality of molecules in a concerted manner relative to the surface so as to move said fluid.

2. The device of claim 1 wherein the surface is an interior surface of a conduit.

3. The device of claim 2 wherein said at least one electromagnetic field generator is a plurality of electromagnets encompassing said conduit.

4. The device of claim 3 wherein said plurality of electromagnets are sequentially energized to create a waveform.

5. The device of claim 1 wherein said at least one electromagnetic field generator is energized to attract said plurality of molecules to the surface.

6. The device of claim 1 wherein said at least one electromagnetic field generator is energized to repulse said plurality of molecules from the surface.

7. The device of claim 1 wherein the surface is an exterior surface.

8. The device of claim 1 wherein said at least one photonic generator is a fiber optic emitting a wavelength inducing a movement in said plurality of molecules.

9. A process for moving fluid comprising the steps of:
placing a surface into contact with a fluid, the surface having bound thereto a plurality of molecules each containing a ferromagnetic moiety; and
activating an electromagnet in proximity to the surface so as to urge said plurality of molecules into a concerted movement relative to the surface.

10. The process of claim 9 wherein the electromagnet polarity is alternated.

11. The process of claim 9 further comprising the step of placing a plurality of electromagnets proximal to the surface and sequentially activating the electromagnets.
